(19) United States
(12) Patent Application Publication
(10) Pub. No.: US 2015/0193470 A1
(43) Pub. Date: Jul. 9, 2015

(54) DYNAMIC STREET HEAT MAP

(71) Applicant: Walid Romaya, San Diego, CA (US)

(72) Inventor: Walid Romaya, San Diego, CA (US)

(21) Appl. No.: 14/593,615

(22) Filed: Jan. 9, 2015

Related U.S. Application Data
(60) Provisional application No. 61/925,330, filed on Jan. 9, 2014.

(51) Int. Cl. G06F 17/30; G09G 5/377; G06Q 50/16; G09G 5/02

(52) U.S. Cl. CPC G06F 17/30241; G09G 5/02; G09G 5/377; G06F 17/30864; G06Q 50/16; G09G 2340/12

(57) ABSTRACT

System and method of generating an interactive map for a geographic area based on user search request, wherein the interactive map is comprised of map characteristics and at least one color coded street overlay above streets. The interactive map configured to dynamically update upon user filter selection, wherein the color coded street overlay is comprised of an aggregation of a plurality of assigned color values each corresponding to a specific property addresses within a street. Each of the property addresses is assigned a color value based on the property value characteristics and corresponding determined color value ranges, wherein determining the property value characteristic for a specific property address based on its own property value characteristic, or property value characteristic of neighboring, adjacent, or like properties.

### RELATED APPLICATION(S)

This application claims the benefit of U.S. Provisional Patent Application No. 61/925,330, filed on Jan. 9, 2014, which is hereby incorporated by reference in its entirety.

### FIELD OF THE INVENTION

The described technology is directed to the field of dynamic mapping techniques.

### BACKGROUND OF THE DISCLOSURE

As consumers get more comfortable using the internet as a means to search for real estate, they will become more reliant on maps that provide them with data that sits on top of the map to help them make informed real estate transactions with or without agent representation. As consumers begin to rely on proprietary mapping techniques of real estate listing search providers, they will begin to demand more data in one screen rather than having to scroll down to review data in list form, or navigate to another screen in order to get the data they need. Moreover, as consumer begin to research a geographic area of interest, they will require more precise data for specific sub-regions within a geographic area, as they will want to compare properties as related to their physical location to shopping, entertainment, schools, libraries, etc Thus, there is a need to provide real estate data onto an interactive map that can be easily be interpreted and adjusted by the consumer in real-time.

### SUMMARY OF THE DISCLOSURE

System and method of generating an interactive map for a geographic area based on user search request, wherein the interactive map is comprised of map characteristics and at least one color coded street overlay above streets. The interactive map configured to dynamically update upon user filter selection, wherein the color coded street overlay is comprised of an aggregation of a plurality of assigned color values each corresponding to a specific property addresses within a street. Each of the property addresses is assigned a color value based on the property value characteristics and corresponding determined color value ranges, wherein determining the property value characteristic for a specific property address based on its own property value characteristic, or property value characteristic of neighboring, adjacent, or like properties.

A computer-implemented method of providing real estate data on an interactive map, under control of one or more computing devices, configured with specific computer-executable instructions for receiving a search request based on a specified geographic area, determining a property value characteristic for each property address within the specified geographic area in response to the search request, assigning a corresponding color value to the property value characteristic based on a range, aggregating the color value for each property address within the geographic area to generate a color coded street overlay based on the range, generating an interactive map comprising, a plurality of map characteristics; and the color coded street overlay for the specified geographic area displayed within the interactive map.

Determining the property value characteristic for a specific property address may be based on property value characteristics of adjacent or similar properties. The color value is an actual numeric value which corresponds to a specific color displayed within the interactive map. The range is a dynamic color display range which adjusts property value characteristic to color value associations based on minimum and maximum values identified within the geographic region. The color coded street overlay is an overlay that resides on top of physical streets within the interactive map which comprises an aggregation of a plurality of assigned color values each corresponding to a specific property addresses within a street based on the range in order to illustrate property value characteristic for each property address within a street.

### BRIEF DESCRIPTION OF THE DRAWINGS

These and other features will now be described below with reference to the drawings summarized below. These drawings and the associated description are provided to illustrate a preferred embodiment of the invention, and not to limit the scope of the invention.

FIG. 1 is block diagram illustrating communications between the communication server, client devices, and data providers of the present disclosure.

FIG. 2 is a block diagram illustrating the hardware components of an exemplary computer system for use with the present disclosure.

FIG. 3 is a flow chart illustrating generating an interactive map based upon user request.

FIG. 4 is an illustration of an exemplary user interface of an interactive map comprising a colored street overlay.

### DETAILED DESCRIPTION

One non-limiting advantage of the described systems and methods is the ability to generate an interactive map that provides visual street overlay layered onto a street within a map that provides users with quick sense of property values within a street.

Another non-limiting advantage of the described systems and methods is the ability to adjust filter selection of an interactive map in order to generate a desired interactive map with visual street overlay based upon a desired filter, such as, listing price, sales price, sale price per square foot, property values, rental prices.

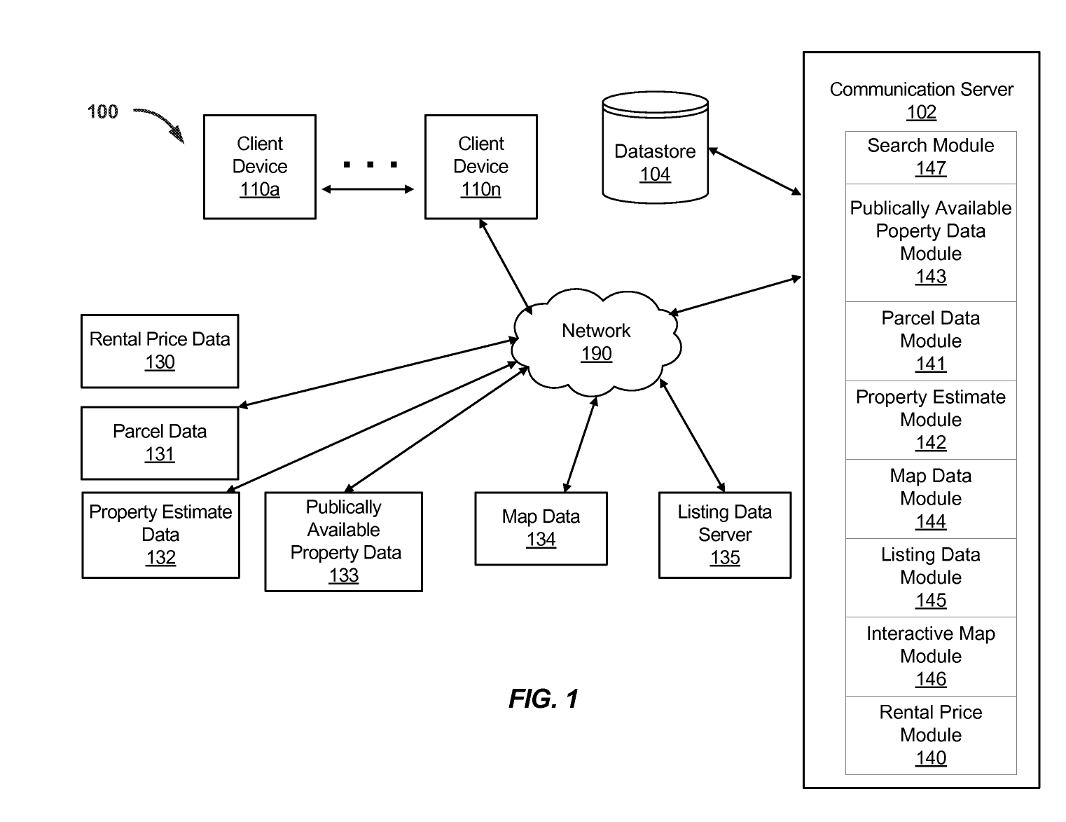

Example implementations of the systems and methods of the current disclosure are described below in further detail in connection with FIGS. 1-4.

FIG. 1 is a functional block diagram illustrating communications between the communication server, client devices, and data providers of the present disclosure. The system 100 may be implemented via a client-server architecture where a client device has an application running locally that performs a set of functions that require communication with a server in order to support desired functionality. The client application may be configured to allow users to input their desired request of the application, after which the request is sent to the server for processing. The server may be configured to optionally archive some information and the request may be routed either back to the initiating user and/or to a target user device. The system 100 shown includes multiple client devices (e.g., a client device 110a and a client device 110n). It will be appreciated that fewer or more client devices may be included in the system 100. The client device 110a and the client device 110n (collectively or individually hereinafter referred to as “client device 110”) may be an electronic communication device configured to transmit and receive communication to and from the communication server 102. Examples of such electronic communication devices include Smartphone's, feature phones, laptop computers, desktop computers, tablet computers, personal digital assistants, set-top devices, gaming consoles, automotive dashboard systems, kiosks, self-service consoles, and the like.

The system 100 includes a network 190. The client device 110 may be configured to transmit and receive messages via the network 190. Examples of the network 190 include a wide area network (WAN), metropolitan area network (MAN), local area network (LAN), wireless local area network (WLAN), or personal area network (PAN). Although shown as one network, the network 190 may include several interconnected networks. The networks which may be included in the system 100 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.).

The communication server 102, by means of the listing data module 145, may request data from the listing data server 135 and the listing data server 135 may in response transmit listing data (i.e. MLS data) into the communication server 102. In some implementations, it may be desirable to have the listing server 126 automatically configured to communicate directly with the communication server 102 based upon a rule/condition that is satisfied. The listing data server 135 may be configured to maintain up to date information regarding property listing information, such as multiple listing service (MLS) repository.

The communication server 102, by means of the map data module 142, may request data from the map data 134 and the map data 134 may in response transmit map data into the communication server 102. In some implementations, it may be desirable to have the map data 134 automatically configured to communicate directly with the communication server 102 based upon a rule/condition that is satisfied. The map data 134 may be configured to maintain up to data information regarding map information, such as Google maps available via application program interface (API) call.

The communication server 102, by means of the publically available property data module 143, may request data from the publically available property data 133 and the publically available property data 133 may in response transmit publically available property data into the communication server 102. In some implementations, it may be desirable to have the publically available property data 133 automatically configured to communicate directly with the communication server 102 based upon a rule/condition that is satisfied. The publically available property data 133 may be configured to maintain up to data information regarding publically available property information, such as mortgage data, tax data, non-payment data, foreclosure data, crime data, school assignment data, easements, liens, etc.

The communication server 102, by means of the property estimate module 142, may request data from the property estimate data 132 and the property estimate data 132 may in response transmit property estimate data into the communication server 102. In some implementations, it may be desirable to have the property estimate data 132 automatically configured to communicate directly with the communication server 102 based upon a rule/condition that is satisfied. The property estimate data 132 may be configured to maintain up to data information regarding property value estimates information.

The communication server 102, by means of the parcel data module 141, may request data from the parcel data 131 and the parcel data 131 may in response transmit parcel data into the communication server 102. In some implementations, it may be desirable to have the parcel data 131 automatically configured to communicate directly with the communication server 102 based upon a rule/condition that is satisfied. The parcel data 131 may be configured to maintain up to data information from local counties/cities/states (geographic regions) as related to parcel maps, parcel information, parcel property tax assessments, etc.

The communication server 102, by means of the rental price module 140, may request data from the rental price data 130 and the rental price data 130 may in response transmit rental price data into the communication server 102. In some implementations, it may be desirable to have the rental price data 130 automatically configured to communicate directly with the communication server 102 based upon a rule/condition that is satisfied. The rental price data 130 may be configured to maintain up to data information from local rental directories as related to rental prices for a specified region.

The datastore 104 may store user information, publically available property data, map data, MLS (listing) data, property estimate data, parcel data, rental price data, and street value data, among variety of data stored in the datastore 104. The datastore may receive requests from the communication server 102 to provide information stored within the datastore 104. The datastore 104 may receive request from the communication server 102 to store information within the datastore 104. The datastore 104 may be updated to store only a specified amount of data in order to maintain performance peeks, in example, the datastore 104 may only keep the last 30 days worth of data for certain data types stored in the datastore 104.

The communication server 102 is configured as a hub to communication activities within the system 100. The communication server 102 is configured to receive client device requests, execute intermediary processing with external and internal software and hardware components, and transmit response to client device 110. The communication server 102 is configured to communicate with the datastore 104 to archive, request and receive information.

Each of the identified external data sources to the communication server 102 (in example, rental price data 130, parcel data 131, property estimate data 132, publically available property data 133, map data 134 and listing data server 135, other others external data sources) have a corresponding module within the communication server (in example, publically available data module 143, parcel data 141, property estimates module 142, map data 144, listing data module 145, rental price module 140) in order to execute program instructions to generate an interactive map which displays both parcel maps and customizable colored street overlay based on real estate data gathered from multiple external data sources.

The communication server 102 may comprise a search module 147 configured to receive a plurality of user search requests, transmit a plurality of map requests to a map data module to handle the plurality of search requests, or may query the datastore 104 for information to handle the search request then transmit to the interactive map module 146.

The communication server 102 may comprise an interactive map module 146 configured to execute program instructions to assign a plurality of property addresses with respective color value specific to a user selectable filter criteria. The interactive map module 146 may act much like an engine which assigns a specific address with a specific color value based on property value characteristics (such as, listing price, sale price, sale price per square foot, property value estimates, or rental price, etc.).

In another embodiment, the interactive map module 146 may act much like a street heat map engine which (1) determines the property value characteristic for a specific property address based on its property value characteristic, or property value characteristic of neighboring, adjacent, or like properties and (2) assign a corresponding color value to the property value characteristic previously determined, and may optionally (3) aggregate the color value for each specific property address within a specific street in order to (4) generate a colored street overlay for all property addresses within a specific street. The resulting colored street overlay will comprise a variety of colors because each property address will be given a specific color value. The assigned color value may be based upon a color range value determined for each filter 532 (FIG. 5).

In one embodiment, the interactive map module 146 may act much like a street heat map engine which (1) determines the property value for a specific property address based on its property value, or property values of neighboring, adjacent, or like properties and (2) assign a corresponding color value to the property value previously determined, and may optionally (3) aggregate the color value for each specific property address within a specific street in order to (4) generate an interactive map with a colored street overlay for all property addresses within a specific street. The resulting colored street overlay will comprise a variety of colors because each property address will be given a specific color value. The assigned color value may be based upon a color range value determined for each filter 532 (FIG. 5).

In another embodiment, the interactive map module 146 may act much like a street heat map engine which (1) determines the listing price characteristic for a specific property address based on its listing price, or listing price of neighboring, adjacent, or like properties and (2) assign a corresponding color value to the listing price previously determined, and may optionally (3) aggregate the color value for each specific property address within a specific street in order to (4) generate a colored street overlay for all property addresses within a specific street. The resulting colored street overlay will comprise a variety of colors because each property address will be given a specific color value. The assigned color value may be based upon a color range value determined for each filter 532 (FIG. 5).

In another embodiment, the interactive map module 146 may act much like a street heat map engine which (1) determines the listing price for a specific property address based on its sale price, or sale price of neighboring, adjacent, or like properties and (2) assign a corresponding color value to the sale price previously determined, and may optionally (3) aggregate the color value for each specific property address within a specific street in order to (4) generate a colored street overlay for all property addresses within a specific street. The resulting colored street overlay will comprise a variety of colors because each property address will be given a specific color value. The assigned color value may be based upon a color range value determined for each filter 532 (FIG. 5).

In another embodiment, the interactive map module 146 may act much like a street heat map engine which (1) determines the sale price per square foot for a specific property address based on its sale price per square foot, or sale price per square foot of neighboring, adjacent, or like properties and (2) assign a corresponding color value to the sale price per square foot previously determined, and may optionally (3) aggregate the color value for each specific property address within a specific street in order to (4) generate a colored street overlay for all property addresses within a specific street. The resulting colored street overlay will comprise a variety of colors because each property address will be given a specific color value. The assigned color value may be based upon a color range value determined for each filter 532 (FIG. 5).

In another embodiment, the interactive map module 146 may act much like a street heat map engine which (1) determines the rental price for a specific property address based on its rental price, or rental price of neighboring, adjacent, or like properties and (2) assign a corresponding color value to the rental price previously determined, and may optionally (3) aggregate the color value for each specific property address within a specific street in order to (4) generate a colored street overlay for all property addresses within a specific street. The resulting colored street overlay will comprise a variety of colors because each property address will be given a specific color value. The assigned color value may be based upon a color range value determined for each filter 532 (FIG. 5).

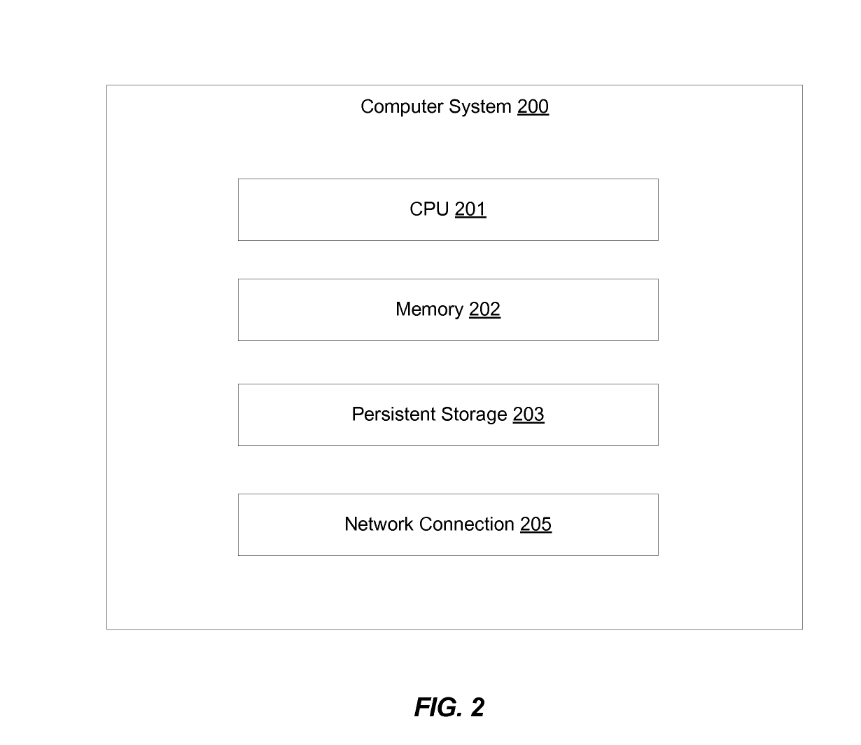

FIG. 2 is a block diagram illustrating the hardware components of an exemplary computer system for use with the present disclosure. These computer systems and devices 200 may include one or more central processing units (“CPUs”) 201 for executing computer programs; a computer memory 202 for storing programs and data while they are being used; a persistent storage device 203, such as a hard drive for persistently storing programs and data; and a network connection 205 for connecting the computer system to other computer systems, such as via the Internet.

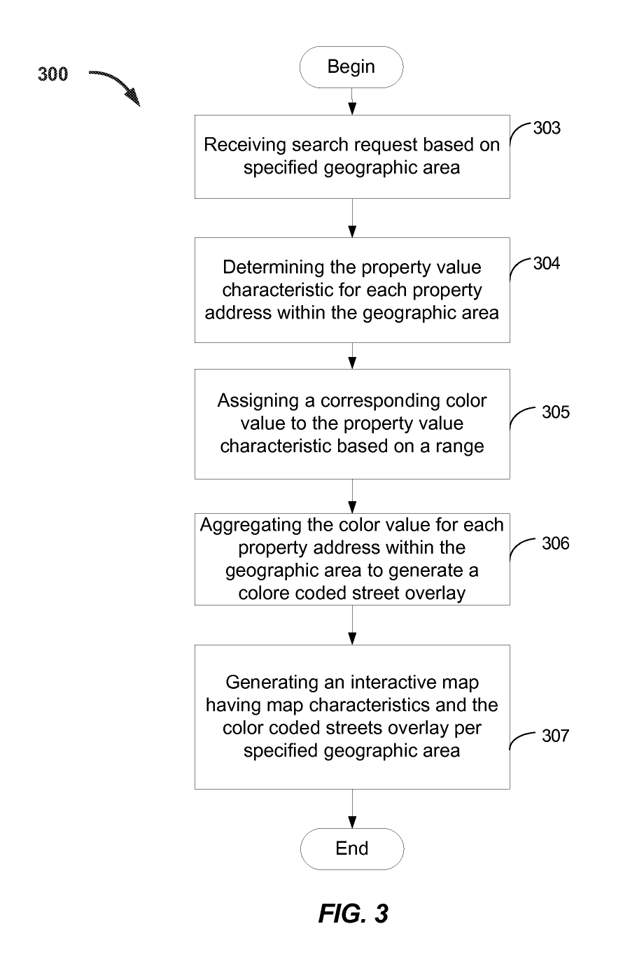

FIG. 3 is a flow chart illustrating generating an interactive map based upon user request. The method shown in FIG. 3 may be implemented in the communication server 102 in communication with the datastore 104 as shown in FIG. 1. FIG. 3 illustrates the method of generating an interactive map with street colored overlay based upon property value characteristic selection. Other filters may be selected by the user, and as a result, the interactive map results would be modified as a result of user filter selection.

At block 303, the communication server 102 may receive search request based on geographical area and filter selection criteria. In one embodiment, the communication server 102 may receive a request from the user to search for properties value characteristics (such as, listing price) within a specific address or zip code. After receiving the initial user search request, then the process may continue to block 304.

At block 304, the interactive map module 146 determines the property value characteristic for each property address within the geographic area. The interactive map module 146 may determine the property characteristic value for a specific property address based on its property characteristic value, or property characteristic value of neighboring, adjacent, or like properties. After determining the property characteristic value for each property within the requested geographic region, then the process continues to block 305.

At block 305, the interactive map module 146 assigns a corresponding color value to the property characteristic value previously determined in block 304 based upon the property characteristic value range determined for the selected property characteristic. After assigning the color value to the determined property characteristic value, then the process continues to block 306.

At block 306, the interactive map module 146 aggregates the color value for each property address within the geographic area to generate a colored street overlay on to a requested interactive map. After aggregating the color value for each property address within the geographic area, then the process continues to block 307.

At block 307, the interactive map module 146 generates an interactive map having map characteristics and the colored street overlay per specified geographic region. After generating the interactive map, then the process ends.

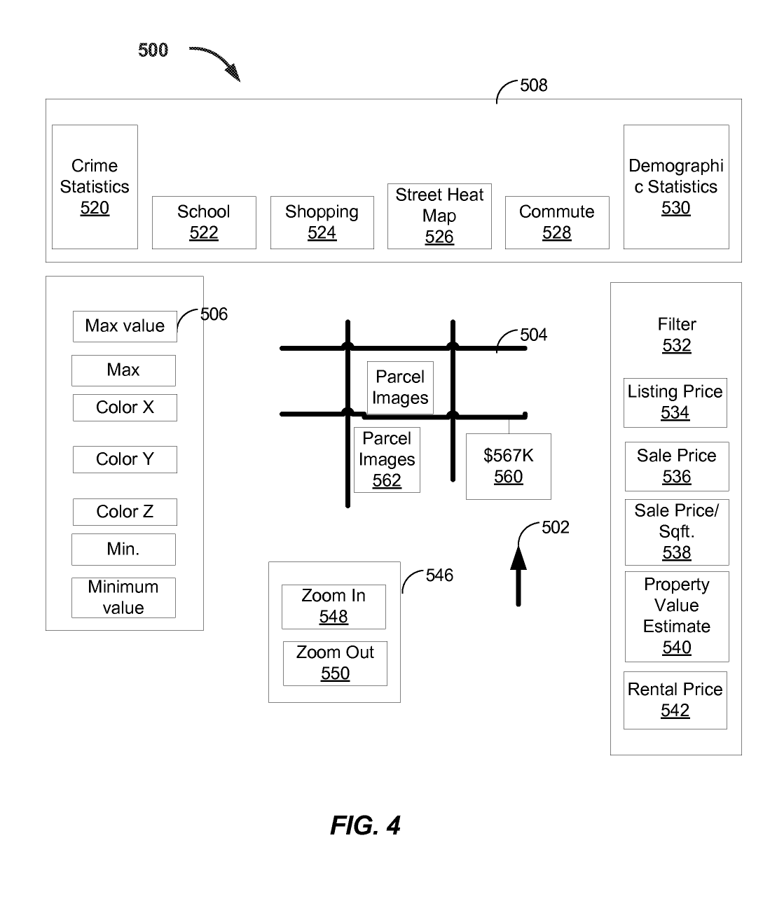

FIG. 4 is exemplary user interface of an interactive map comprising a colored street overlay. In one embodiment, an interactive map 500 which allows for user selection of a primary filter 508 comprising: crime statistics 520, school 522, shopping 524, street heat map 526, commute 528 and demographics 530.

On the condition that crime statistics 520 is selected by the user, then the interactive map 500 may display an overlay of crime statistics data in a form of color coded overlay and a range value display 506 which acts as a legend to decode color into approximate data values.

On the condition that school 522 is selected by the user, then the interactive map 500 may display an overlay of school district maps in a form of color coded overlay and a range value display 506 which acts as a legend to decode the color into specific schools or school districts. Alternatively, if school 522 is selected by the user, then the interactive map 500 may display pin drops (geo-location markers) as to where the school are located within the interactive map 500.

On the condition that shopping 524 is selected by the user, then the interactive map 500 may display an overlay of shopping district maps in a form of color coded overlay and a range value display 506 which acts as a legend to decode the color into specific shops or shopping districts. Alternatively, if shopping 524 is selected by the user, then the interactive map 500 may display pin drops (geo-location markers) as to where the shopping areas are located within the interactive map 500.

On the condition that commute 528 is selected by the user, then the interactive map 500 may display an overlay of commute statistic data in a form of color coded overlay and a range value display 506 which acts as a legend to decode color into approximate data values. If demographics statistics 530 is selected by the user, then the interactive map 500 may display an overlay of demographic data in a form of color coded overlay and a range value display 506 which acts as a legend to decode color into approximate data values.

In one embodiment, on the condition that street heat map 526 is selected by the user, then the interactive map 500 may display parcel images 562 and a color coded street overlay 504 onto streets within the interactive map 500 and a range value display 506 which acts as a legend to decode color into approximate data values. Alternatively, if the street heat map 526 is selected by the user, then the interactive map 500 will display a color coded street overlay 504 onto streets within the interactive map 500 and as the user uses an mouse cursor 502 to move through any one street, then a small panel 560 my display real estate data (such as, listing price, sale price, sale price per square foot, property value estimates, rental price).

In another embodiment, on the condition that the street heat map 526 is selected, the interactive map 500 may be automatically defaulted to a specific filter selection 532, such as property value estimate 540, but the user will have the ability to modify the filter selection 532 by selecting any available filter selection 532 options. As a result of modifying the filter selection 532, the interactive map 500 may adjust its color coded street overlay 504 because each filter selection 532 may be assigned corresponding color value range within the interactive map module 146 which may responsible for determining street heat map values and assigning those values a corresponding color value in order to generate an interactive map comprising map characteristics, parcel characteristics, and colored street overlay 504.

The street heat map shown in FIG. 4 may be a layer over the interactive map 500 where the individual streets within the map 500 are color coded to reflect median values for properties in the specific street and the average value per square foot for the properties in the specific street. The colors for each street may change depending on the median values for properties in the specific street and the average value per square foot for the properties in the specific street. An algorithm of the median values for properties in the specific street and the average value per square foot for the properties in the specific street is calculated based on multiple factors, a combination that may include historical sales prices, assessor's tax records, and number of properties in street, geographic location of properties within street, and likely other factors. The specific colors are indicated on a scale whereby the lower values reflect first colors such as blue colors and the higher values are second colors such as red colors with a combination of colors and hues in between.

In another embodiment, as a mouse cursor 502 is hovered over the colored street a small panel 560 will show the median value for the street and the average per sq foot for the street. The values within the panel 560 change depending on the position of the cursor within the street. Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

The interfaces shown represent example implementations of a tangible device configured to perform one or more of the features described. The interface elements may be implemented via the execution of machine readable instructions to generate a graphical representation of the interface on a device. The graphical representation may be, for example, a machine readable mark-up language (e.g., HTML), executable machine readable instructions (e.g., Javascript), or combinations of these or other display technologies. In some implementations, the interface may be constructed of physical components such as buttons, circuits, lights, and the like. The interface components may be controlled by a circuit configured to implement the methods described above. In some implementations, it may be desirable to control the interface components via a processor configured to execute stored instructions which cause the interface components to perform aspects of the methods described.

As used herein, the terms “display” or “displaying” encompass a variety of actions. For example, “displaying” may include presenting in audio form, visual form, or some other form that can be made known to the senses. The term may also include a combination of two or more of the foregoing.

As used herein, the terms “determine” or “determining” encompass a variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A computer-implemented method of providing real estate data on an interactive map comprising:
under control of one or more computing devices configured with specific computer-executable instructions for:
receiving a search request based on a specified geographic area;
determining a property value characteristic for each property address within the specified geographic area in response to the search request;
assigning a corresponding color value to the property value characteristic based on a range;
aggregating the color value for each property address within the geographic area to generate a color coded street overlay based on the range;
generating an interactive map comprising:
a plurality of map characteristics; and
the color coded street overlay for the specified geographic area displayed within the interactive map.

2. The computer-implemented method of providing real estate data on an interactive map of claim 1, wherein the search request is a user request to display search results for real estate within a specific geographic region.

3. The computer-implemented method of providing real estate data on an interactive map of claim 1, wherein the property value characteristic is a property value estimate.

4. A communication server in communication with a datastore of claim 8, wherein determining the property value characteristic for a specific property address is based on property value characteristics of adjacent properties.

5. A communication server in communication with a datastore of claim 8, wherein determining the property value characteristic for a specific property address is based on property value characteristics of similar properties.

6. The computer-implemented method of providing real estate data on an interactive map of claim 1, wherein the color value is an actual numeric value which corresponds to a specific color displayed within the interactive map.

7. The computer-implemented method of providing real estate data on an interactive map of claim 1, wherein the range is a dynamic color display range which adjusts property value characteristic to color value associations based on minimum and maximum values identified within the geographic region.

8. The computer-implemented method of providing real estate data on an interactive map of claim 1, wherein the color coded street overlay is an overlay that resides on top of physical streets within the interactive map which comprises an aggregation of a plurality of assigned color values each corresponding to a specific property addresses within a street based on the range in order to illustrate property value characteristic for each property address within a street.

9. The computer-implemented method of providing real estate data on an interactive map of claim 1, wherein the plurality of map characteristics are generic map characteristics which are present within a generic map including streets, highways, water regions, and undeveloped regions.

10. A communication server in communication with a datastore, comprising:
a hardware implemented search module configured to:
receive a plurality of user search requests;
transmit a plurality of map requests to a map data module to handle the plurality of search requests;
a hardware implemented publically available property data module configured to:
communicate directly with an external publically available property data server to collect data updates and transmit the data updates to the datastore;
a hardware implemented parcel data module configured to:
communicate directly with an external parcel data server to collect data updates and transmit the data updates to the datastore;
a hardware implemented map data module configured to:
receive the plurality of map requests;
query external map data sources; and
transmit a plurality of interactive map requests to an interactive map module;
a hardware implemented listing data module configured to:
communicate directly with an external listing data server to collect data updates and transmit the data updates to the datastore;
a hardware implemented interactive map module configured to:
receive a plurality of interactive map requests;
determines the property value characteristic for a specific property address;
assign a corresponding color value to the property value characteristic previously determined; and
aggregate the color value for each specific property address within a specific street in order to generate an interactive map with a colored street overlay that includes all the property value characteristics for all property addresses within a specific street;
a hardware implemented rental price module configured to:
communicate directly with an external rental price data server to collect data updates and transmit the data updates to the datastore.

11. A communication server in communication with a datastore of claim 8, wherein determining the property value characteristic for a specific property address is based on its own property value characteristic.

12. A communication server in communication with a datastore of claim 8, wherein determining the property value characteristic for a specific property address is based on property value characteristics of adjacent properties.

13. A communication server in communication with a datastore of claim 8, wherein determining the property value characteristic for a specific property address is based on property value characteristics of similar properties.

14. A communication server in communication with a datastore of claim 8, wherein the property value characteristic is a rental price.

15. A communication server in communication with a datastore of claim 8, wherein the property value characteristic is a property value estimate.

16. A communication server in communication with a datastore of claim 8, wherein the color coded street overlay is an overlay that resides on top of physical streets within the interactive map which comprises an aggregation of a plurality of assigned color values each corresponding to a specific property addresses within a street based on the range in order to illustrate property value characteristic for each property address within a street.

17. A real estate listing search system, the system comprising:
a communication server comprising:
a hardware implemented search module configured to:
receive a plurality of user search requests;
transmit a plurality of map requests to a map data module to handle the plurality of search requests;
a hardware implemented map data module configured to:
receive the plurality of map requests;
query external map data sources; and
transmit a plurality of interactive map requests to an interactive map module;
a hardware implemented interactive map module configured to:
receive a plurality of interactive map requests;
determines the property value characteristic for a specific property address based on its property value characteristics, or property value characteristic of neighboring, adjacent, or like properties;
assign a corresponding color value to the property value characteristic previously determined; and
aggregate the color value for each specific property address within a specific street in order to generate an interactive map with a colored street overlay that includes all the property value characteristics for all property addresses within a specific street;
a datastore configured to:
receive and respond to requests from the communication server;
store user information, publically available property data, map data, listing data, property estimate data, parcel data, rental price data, and street value data;
a listing data server configured to:
maintain up-to-date information regarding property listing information.

18. A real estate listing search system of claim 17, wherein the listing data server is a multiple listing service provider.

19. A real estate listing search system of claim 17, wherein A communication server in communication with a datastore of claim 8, wherein determining the property value characteristic for a specific property address is based on property value characteristics of adjacent properties.

20. A real estate listing search system of claim 17, wherein A communication server in communication with a datastore of claim 8, wherein determining the property value characteristic for a specific property address is based on property value characteristics of similar properties.
